(19) United States
(12) Patent Application Publication
(10) Pub. No.: US 2006/0216498 A1
(43) Pub. Date: Sep. 28, 2006

(54) MULTI-COLORED HOUSING FOR A PORTABLE ELECTRONIC DEVICE AND METHOD FOR MAKING THE SAME

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,132

(22) Filed: Mar. 8, 2006

(30) Foreign Application Priority Data
Mar. 25, 2005 (CN) 200510033850.2

(51) Int. Cl. B32B 5/16; B05D 3/02

(52) U.S. Cl. 428/328; 428/330; 428/702; 427/372.2

(57) ABSTRACT

A housing for a portable electronic device includes a molded base and a nano-particle coating. The nano-particle coating is formed on the molded base. The nano-particle coating has nano-particles comprising a material selected from the group of zinc sulfide (ZnS), cadmium sulfide (CdS), tellurium sulfide (TeS), zinc selenide (ZnSe), cadmium selenide (CdSe), cerium oxide (CeO₂), zinc oxide (ZnOₓ), tin oxide (SnO₂), zinc-europium orthosilicate (Eu—ZnSiOₓ), barium-magnesium-europium aluminate (BaMgAlOₓ—Eu), and gadolinium-yttrium-europium borate ((Y, Gd)BO₃—Eu), the nano-particles have predetermined sizes for producing different color.

### FIELD OF THE INVENTION

The present invention generally relates to portable devices, and more particularly, to a housing for a portable electronic device.

### DESCRIPTION OF RELATED ART

Currently, portable electronic devices such as mobile phones and PDAs (personal digital assistants) are in widespread use around the world. There is more and more demand for higher quality and serviceability of these portable electronic devices. Many portable electronic devices are provided with removable panels, which can be changed over for new, more aesthetically pleasing panels when so desired by users.

Removable panels are most commonly used with mobile phones. A user may from time to time want to remove an old panel from a base cover of the mobile phone, and install a newer, more attractive panel on the base cover instead. The new panel must be attached firmly and securely.

However, portable electronic devices with removable panels often suffer from dust contamination, where dust often enters into the interior of the portable electronic devices from the interspaces between the portable electronic devices and the removable panels.

Therefore, an attractive housing for a portable electronic device, which overcomes the above-described problem, is desired.

### SUMMARY OF INVENTION

A housing for a portable electronic device includes a molded base and a nano-particle coating. The nano-particle coating is formed on the molded base. The nano-particle coating has nano-particles comprising a material selected from the group consisting of zinc sulfide (ZnS), cadmium sulfide (CdS), tellurium sulfide (TeS), zinc selenide (ZnSe), cadmium selenide (CdSe), cerium oxide (CeO₂), zinc oxide (ZnOₓ), tin oxide (SnO₂), zinc-europium orthosilicate (Eu—ZnSiOₓ), barium-magnesium-europium aluminate (BaMgAlOₓ—Eu), and gadolinium-yttrium-europium borate ((Y, Gd)BO₃—Eu). The nano-particles have predetermined sizes for producing different color.

Other advantages and novel features will become more apparent from the following detailed description when taken in conjunction with the accompanying drawings.

### BRIEF DESCRIPTION OF DRAWINGS

Many aspects of the housing can be better understood with reference to the following drawings. The components in the drawings are not necessarily to scale, the emphasis instead being placed upon clearly illustrating the principles of the present housing. Moreover, in the drawings, like reference numerals designate corresponding parts throughout the several views.

FIG. 1 is a schematic view of a housing in accordance with a preferred embodiment;

FIG. 2 is a cross-sectional view of the housing along line II-II in FIG. 1; and

FIG. 3 is a flow chart of a method for making the housing in accordance with a preferred embodiment.

### DETAILED DESCRIPTION

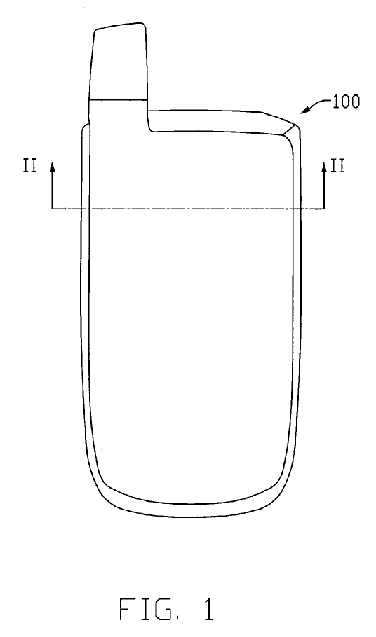

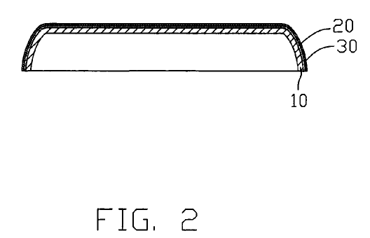

Referring to FIGS. 1 and 2, in a preferred embodiment, a housing 100 includes a molded base 10, a nano-particle coating 20 for producing different colors, and an anti-reflection film 30. The molded base 10 can be a front cover, back cover, flip cover, or slide cover of a portable electronic device. The molded base 10 is, preferably, made of a plastic material or a metal material. The nano-particle coating 20 is formed on an outer surface of the molded base 10, and the anti-reflection film 30 is formed on a surface of the nano-particle coating 20. The nano-particle coating 20 can be formed on all or part of the surface of the base 10.

The nano-particle coating 20 has a plurality of nano-particles which can produce different colors. The nano-particles can be made of a material of a sulfur compound such as zinc sulfide (ZnS), cadmium sulfide (CdS), and tellurium sulfide (TeS), or of a selenide compound such as zinc selenide (ZnSe), and cadmium selenide (CdSe), an oxide compound such as cerium oxide (CeO₂), zinc oxide (ZnOₓ), and tin oxide (SnO₂), a fluorescent material such as zinc-europium orthosilicate (Eu—ZnSiOₓ), barium-magnesium-europium aluminate (BaMgAlOₓ—Eu), or gadolinium-yttrium-europium borate ((Y, Gd)BO₃—Eu), or any desired combination thereof.

The nano-particles can have an average size within the range of 1-100 nanometers. Preferably, the size of the nano-particles is within the range of 2-50 nanometers. When the size of the nano-particles is between 2-8 nanometers, the nano-particle coating 20 will show purple. When the size of the nano-particles is between 9-15 nanometers, the nano-particle coating 20 will look blue. When the size of the nano-particles is between 16-22 nanometers, the nano-particle coating 20 will show cyan. When the size of the nano-particles is between 23-29 nanometers, the nano-particle coating 20 will show green. When the size of the nano-particles is between 30-36 nanometers, the nano-particle coating 20 will show yellow. When the size of the nano-particles is between 37-43 nanometers, the nano-particle coating 20 will show orange. When the size of nano-particles is between 44-50 nanometers, the nano-particle coating 20 will present red. Accordingly, if the size of the nano-particles is between 2-50 nanometers, the nano-particle coating 20 will present multicolor or rainbow colors. Therefore, the housing 100 will have a fashionable and attractive appearance. The nano-particles can be made by a variety of methods such as the nano-solgel process, the wet-grinding process, and the quantum dot process, as long as the desired size of the particles can be achieved.

The anti-reflection film 30 essentially consists of two materials, one with a high refractive index and the other with a low one. The two materials are laminated each other. The high refractive material can be tantalum oxide or titanium trioxide, and the low one can be silicon dioxide. The anti-reflection film 30 acts so as to promote the transmittance of light.

Optionally, the housing 100 can also have a titanium dioxide film deposited on the surface of the anti-reflection film 30. The titanium dioxide film acts so as to sterilize and self-clean the housing.

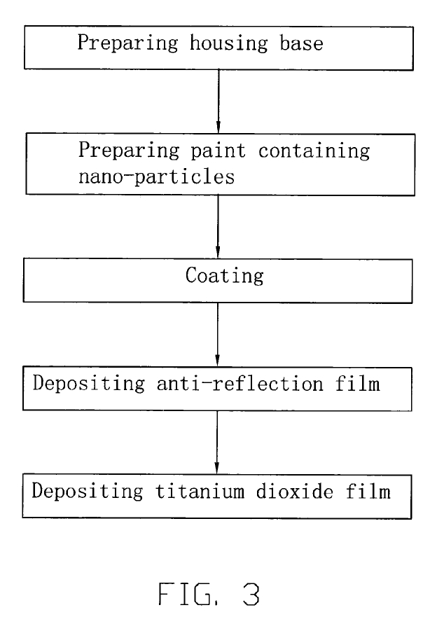

Referring to FIGS. 1-3, an exemplary method for making the housing 100 is provided. Firstly, a base 10 is molded. When the material of the base 10 is plastic, the base 10 is molded by a method of injection molding. When the material of the base 10 is metal, the base 10 is molded by a method of stamping molding. Secondly, the nano-particles are mixed into a paint for coating. Thirdly, a nano-particle coating 20 is coated on outer surface of the base 10 with the paint mixing the nano-particles. The nano-particle coating 20 can be coated with different patterns. Fourthly, an anti-reflection film 30 is deposited on a surface of the nano-particles coating 20 by electron beam evaporation, ion beam assisted deposition, or ion beam deposition. Optionally, a titanium dioxide film can be deposited on the surface of the anti-reflection film 30. Thereby, a housing 100 for a portable electronic device is obtained.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A housing for a portable electronic device, comprising:
a housing base; and
a nano-particle coating formed on the housing base;
wherein the nano-particle coating is made of nano-particles comprising a material selected from the group consisting of zinc sulfide (ZnS), cadmium sulfide (CdS), tellurium sulfide (TeS), zinc selenide (ZnSe), cadmium selenide (CdSe), cerium oxide (CeO₂), zinc oxide (ZnOₓ), tin oxide (SnO₂), zinc-europium orthosilicate (Eu—ZnSiOₓ), barium-magnesium-europium aluminate (BaMgAlOₓ—Eu), and gadolinium-yttrium-europium borate ((Y, Gd)BO₃—Eu), the nano-particles being configured to have a predetermined size for producing different colors.

2. The housing as claimed in claim 1, wherein an anti-reflection film is formed on the nano-particle coating.

3. The housing as claimed in claim 2, wherein the anti-reflection coating essentially consists of a high refractive material and a low refractive material.

4. The housing as claimed in claim 3, wherein the high refractive material is one of tantalum oxide and titanium trioxide.

5. The housing as claimed in claim 3, wherein the low refractive material is silicon dioxide.

6. The housing as claimed in claim 2, wherein a titanium dioxide layer is formed on the anti-reflection coating.

7. The housing as claimed in claim 1, wherein the nano-particle coating is formed on all or part of the surface of the base.

8. The housing as claimed in claim 1, wherein the size of the nano-particles is in the range of 1-100 nanometers.

9. The housing as claimed in claim 8, wherein the size of the nano-particles is in the range of 2-50 nanometers.

10. A portable device, comprising:
a housing, comprising:
a housing base; and
a nano-particle coating formed on the housing base;
wherein the nano-particle coating has nano-particles having a size in the range of 1-100 nanometers, and the material of the nano-particles is selected so that the nano-particles having the size in the range of 1-100 nanometers are capable of producing multicolor.

11. The device as claimed in claim 10, wherein an anti-reflection film is formed on the nano-particles coating.

12. The device as claimed in claim 11, wherein the anti-reflection coating consists of a high refractive material and a low refractive material.

13. The device as claimed in claim 12, wherein the high refractive material is one of tantalum oxide and titanium trioxide, and the low refractive material is silicon dioxide.

14. The device as claimed in claim 11, wherein a titanium dioxide layer is formed on the anti-reflection coating.

15. The device as claimed in claim 10, wherein the material of the nano-particles is one of sulfur compound, selenide compound, oxide compound, and fluorescent material.

16. A method for making a housing, comprising the steps of:
providing a housing base; and
forming a nano-particle coating on a surface of a housing base, wherein the nano-particle coating is made of nano-particles comprising a material selected from the group consisting of zinc sulfide (ZnS), cadmium sulfide (CdS), tellurium sulfide (TeS), zinc selenide (ZnSe), cadmium selenide (CdSe), cerium oxide (CeO₂), zinc oxide (ZnOₓ), tin oxide (SnO₂), zinc-europium orthosilicate (Eu—ZnSiOₓ), barium-magnesium-europium aluminate (BaMgAlOₓ—Eu), and gadolinium-yttrium-europium borate ((Y, Gd)BO₃—Eu), the nano-particles being configured to have a predetermined size for producing different colors.

17. The method as claimed in claim 16, wherein forming the nano-particle coating comprises the step of painting the surface of the housing base with a paint mixing the selected nano-particles.

18. The method as claimed in claim 16, wherein the nano-particles have a size in the range of 2-50 nanometers.

19. The method as claimed in claim 16, further comprising the step of depositing an anti-reflection film on a surface of the nano-particle coating.

20. The method as claimed in claim 16, further comprising a step of depositing a titanium dioxide film on the surface of the anti-reflection film.
